(19) United States
(12) Patent Application Publication
(10) Pub. No.: US 2009/0205164 A1
(43) Pub. Date: Aug. 20, 2009

(54) Castor Wheel Assembly

(76) Inventor: Albert W. Larson, Selkirk (CA)

Correspondence Address: ADE & COMPANY INC., 2157 Henderson Highway, WINNIPEG, MB, R2G1P9, CA

(21) Appl. No.: 12/362,609

(22) Filed: Jan. 30, 2009

Related U.S. Application Data
(60) Provisional application No. 61/029,671, filed on Feb. 19, 2008.

(51) Int. Cl. B60B 33/04

(52) U.S. Cl. 16/44

(57) ABSTRACT

A castor wheel assembly comprises a tubular casing of rectangular cross section extending in axial direction between a pair of opposed ends and a swivel member for connecting the casing to an object supported thereon for relative rotation about a vertical swivel axis. A shaft extends horizontally through the casing for connection to pivot arms at opposed ends thereof. A castor wheel is coupled between the pivot arms spaced radially outwardly from the shaft. A flange spans radially from the shaft a fully width of the casing along a length of the shaft. Elastomeric material supports the shaft and the flange along one wall of the casing such that the elastomeric material is arranged to be compressed between the flange and an opposing wall of the casing by rotation of the shaft resulting from upward deflection of the wheel relative to the casing.

This application claims the benefit under 35 U.S.C.119(e) of U.S. provisional application Ser. No. 61/029,671, filed Feb. 19, 2008.

### FIELD OF THE INVENTION

The present invention relates to a caster wheel assembly of the type including a base member for attachment to an object to be supported, a swivel member mounted on the base member for rotation about a vertical swivel axis, a wheel mounted on the swivel member for rotation about a horizontal axis offset to one side of the vertical swivel axis and suspension means between the wheel and the swivel member to allow some flexing of the wheel in a vertical direction in response to impact with uneven terrain, curbs or the like.

### BACKGROUND

Sprung caster wheel assemblies of the above type are well known and are used on many different types of equipment for supporting the equipment in movement across the ground. One particular area where castor wheels of this type are used is in relation to pallet lifting dollies. Such pallet dollies include a pair of parallel lifting bars each having a ground wheel at an outer end thereof. At an inner end of the bars is provided a main support structure with a manual control unit, the main supporting structure including a main central wheel acting as drive and steering wheel in what is essentially a three wheeled unit. In order to prevent tilting of the main unit to each side there is provided a pair of castor wheels one on each side of the main drive wheel. These castor wheels are sprung so the wheel can lift slightly to accommodate uneven terrain or impact with curbs or the like. However one prior construction is relatively complex and expensive and also is prone to damage since the main side plates supporting the wheels are not sprung and if they should impact a curb, the full impact is taken within the swivel joint often causing damage.

Conventional sprung castor wheels typically involve a spring which is mounted under tension or under compression as described in U.S. Pat. No. 6,539,578 to Guttmann et al. The orientation of the spring in this instance limits the amount of overall deflection permitted. It is common for the spring to deflect to its minimum length at which point no further suspension is provided and the castor is subject to damage upon further impact.

Other forms of suspension in a castor wheel involve the use of elastomeric materials supported under compression or torsion. Examples of castor wheels using elastomeric materials are found in the following document: U.S. Pat. No. 4,559,669 belonging to Bonzer et al.; U.S. Pat. No. 4,462,138 belonging to Black; U.S. Pat. No. 4,346,498 belonging to Welsch et al.; U.S. Pat. No. 2,442,831 belonging to Suttles; German patent 617428 and UK patent 860,352. In each instance in the prior art, the elastomeric material is typically mounted in such a manner so as to limit the load being applied due to the unconstrained manner in which the elastomeric material is supported or such that only a limited deflection of the castor wheel is permitted. Accordingly, the prior art designs are not well suited to many industrial applications.

U.S. Pat. No. 5,448,796 to Larson discloses another example of a castor wheel assembly using elastomeric materials in which a tubular casing supports a shaft extending therethrough for relative rotation about a horizontal pivot axis of the castor wheel. The shaft is centrally supported in the casing by elastomeric material on all sides such that over rotation of the shaft may cause the shaft to slip into an over-rotated condition by rotating the surrounding elastomeric material with the shaft relative to the casing instead of the elastomeric material biasing the castor wheel back to an undeflected position relative to the casing, thus limiting the amount of deflection and load size permitted.

### SUMMARY OF THE INVENTION

According to one aspect of the invention there is provided a castor wheel assembly for supporting an object thereon for rolling movement along the ground, the assembly comprising:

a base member arranged for supporting the object thereon;

a tubular casing extending in axial direction between a pair of opposed ends of the casing;

a swivel member supporting the base member on the tubular casing for relative rotation about a vertical swivel axis;

a shaft extending through the tubular casing between the opposed ends of the casing and being supported for pivotal movement relative to the casing about a first horizontal axis extending in the axial direction between the opposed ends of the casing;

a pair of arms coupled to the shaft at the opposed ends of the casing respectively so as to be arranged for rotation with the shaft relative to the casing about the first horizontal axis;

a wheel coupled between the pair of arms for rotation about a second horizontal axis oriented parallel to and spaced from the first horizontal axis;

the wheel extending below a bottom edge of the arms so as to be arranged for rolling engagement along the ground;

the shaft comprising at least one flange portion which is rotatable with the arms relative to the casing about the first horizontal axis;

said at least one flange portion spanning radially from the first horizontal axis along a length of the shaft between the opposed ends of the casing;

elastomeric material supporting the shaft in the casing in abutment with one wall of the casing such that the elastomeric material spans between the shaft and an opposing wall of the casing;

the elastomeric material being arranged to be compressed by relative rotation between the shaft and the casing responsive to upward deflection of the castor wheel relative to the casing.

By providing a shaft with a flange portion in abutment against one wall of the tubular casing, the elastomeric material supports the shaft such that its rotation can be leveraged against the wall of the casing while the elastomeric material can span substantially the full dimensions of the casing. In this arrangement the wheel can be deflected through a greater range of movement and can be subjected to a much larger range of force without concern of the shaft over rotating relative to the surrounding casing as in the prior art noted above. The construction of the shaft and flange portion in abutment with the wall of the casing permits a simple manufactured structure in which the shaft and elastomeric material are simply slidably received through the casing for low cost and ease of assembly.

Said at least one flange portion preferably comprises a single flange abutted along one wall of the casing.

The first horizontal axis may be located adjacent a top wall of the casing.

Said at least one flange portion is preferably arranged to span substantially a full cross sectional dimension of the casing.

When the flange portion is arranged to lay flat against one wall of the housing, preferably the elastomeric material spans between the flange portion and an opposing wall of the casing lying parallel to the flange portion.

When the casing is square in cross section, the first horizontal axis is preferably positioned in one corner of the square cross section of the casing. In this instance, the flange portion may span a full distance between two adjacent corners of the square cross section of casing so as to depend downwardly from the first horizontal axis to span a full height of the casing.

The elastomeric material is preferably arranged to substantially fill the casing between the single flange portion adjacent one wall of the casing and remaining ones of the walls of the casing.

Accordingly, the elastomeric material is preferably arranged to span continuously across a full cross section of the casing between two opposed walls of the casing.

When the flange portion is located adjacent one wall of the casing, there may be provided an adjustment screw threadably received through said one wall so as to be arranged to displace the flange portion away from said one wall to pre-compress the elastomeric material such that the castor wheel is deflected upwardly relative to the casing.

The vertical swivel axis is preferably arranged to be offset from the first horizontal axis. In this instance, the shaft and elastomeric material may be arranged to be supported in the casing in at least two different orientations which are reversible relative to one another. Preferably radial distances of the second horizontal axis of the wheel relative to the vertical swivel axis are different form one another in the two orientations for adjusting the radius of rotation of the wheel about the vertical swivel axis as may be desired.

When the tubular casing is square in cross section so as to define four walls, the shaft is preferably abutted against two adjacent walls of the casing by the elastomeric material.

Some embodiments of the invention will now be described in conjunction with the accompanying drawings in which:

### BRIEF DESCRIPTION OF THE DRAWINGS

FIG. 1 is a perspective view of the castor wheel assembly.

FIG. 2 is an exploded perspective view of the castor wheel assembly according to FIG. 1.

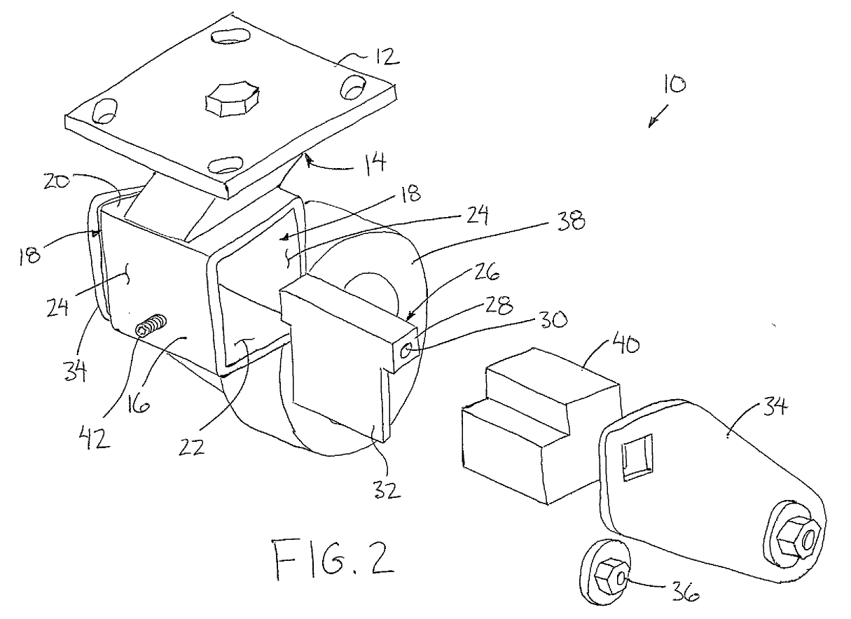

FIG. 3 is a side elevational view of the castor wheel assembly according to FIG. 1 with one of the pivot arms shown removed.

FIG. 4 is a side elevational view of an alternative mounting configuration of the castor wheel assembly according to FIG. 1.

FIG. 5 is a schematic elevational view of a further embodiment of the positioning of the shaft within the casing.

In the drawings like characters of reference indicate corresponding parts in the different figures.

### DETAILED DESCRIPTION

Referring to the accompanying figures there is illustrated a castor wheel assembly generally indicated by reference numeral 10. The assembly 10 is particularly suited for industrial use where suspension is desired for an object being supported on the castor wheel assembly for rolling movement along the ground.

The assembly 10 includes a base member 12 comprising a flat mounting plate which is square and includes mounting apertures located at each of the four corners thereof. A top surface of the base member is arranged to support the object thereon to which the base member is secured by fasteners extending through the apertures in the corners thereof. A bottom side of the base member 12 faces downwardly for joining a swivel member 14 as describe further below.

The assembly 10 further includes a tubular casing 16 which is square in cross section and extends in an axial direction between two opposed open ends 18. The casing includes a top wall 20 and a bottom wall 22 opposite one another which extend parallel, generally horizontally, between the opposed ends. Two side walls 24 are joined vertically between the top and bottom walls, parallel and opposite one another to similarly extend between the open ends of the casing.

The swivel member 14 is coupled to the top wall 20 of the tubular casing for connecting the casing to the base member 12 for relative rotation therebetween about a vertical swivel axis. The swivel axis is centered in the axial direction between the opposed ends 18 of the tubular casing while being offset relative to the two side walls 24 so as to be closer to one side wall than the other.

A shaft 26 is provided which extends through the tubular casing 16 in the axial direction thereof between the opposed ends of the casing. The shaft 26 includes a core portion 28 which projects outwardly from the casing at both ends through and beyond the open ends of the casing. The core portion 28 is generally square in cross section. An internally threaded bore 30 is provided at each end of the core portion 28. The core portion is arranged to be supported at an upper one of the corners of the square cross section of the tubular casing for abutment against the top wall and one of the adjacent side walls 24 along the length thereof between the open ends of the casing.

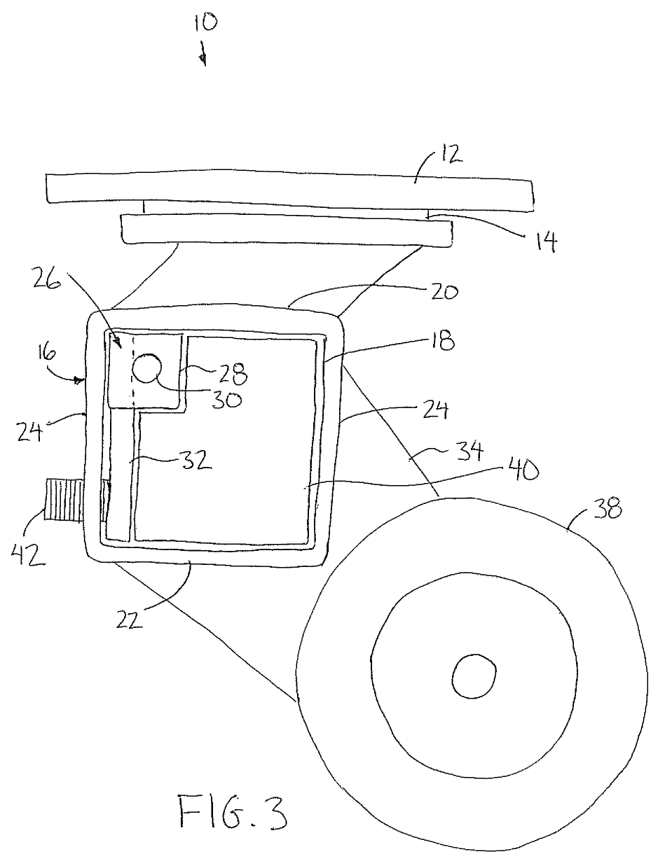

The shaft also includes a flange portion 32 which is integrally cast to be continuous with the core portion 28 along a length of the shaft between the opposed ends. The flange portion 32 extends radially outward relative to a longitudinal axis of the core portion 28 along a full length of the shaft between the opposed ends of the casing. The flange portion 32 also extends in the radial direction across a full cross sectional dimension of the casing to span a height of one of the side walls 24 of the casing. As shown in the configuration of FIG. 3, the flange portion 32 depends downwardly from the core portion 28 flat against the side wall the full height of the casing between the top and bottom walls thererof.

Two pivot arms 34 are supported at opposing ends of the casing respectively. Each pivot arm comprises a plate supported at a respective end of the shaft 26 to lie perpendicularly to a longitudinal axis of the shaft extending in the axial direction through the casing. The two plates are thus parallel and spaced apart from one another at opposing ends of the casing with the plates being oriented to span across and enclose the opposed open ends of the casing respectively. Each plate forming the pivot arms 34 includes a socket of square cross section formed therethrough which mates with the cross section of the ends of the core portion 28 for interlocking engagement between the opposed ends of the shaft 26 and the sockets in the pivot arms 34 respectively.

A suitable fastener 36 is received within each of the threaded bores 38 at the opposed ends of the shaft to retain the pivot arms 34 fastened to the opposed ends of the shaft such that the shaft and pivot arms are pivotal together about the longitudinal axis of the shaft relative to the surrounding casing. As shown in FIG. 3, the plates extend from an inner end supported at the respective end of the shaft downwardly and radially outward relative to the axis of the shaft to respective free outer ends spaced radially outward from the casing for mounting a castor wheel 38 thereon.

A block of elastomeric material 40 is mounted within the tubular casing to span a full height of the casing between the opposed top and bottom walls as well as spanning a full lateral distance of the casing between the flange portion 32 against one of the side walls 24 and the opposing one of the side walls 24. The elastomeric material 40 is formed as a single integral block which spans continuously across a full cross section of the interior of the casing so that the interior of the casing which remains after receiving the shaft 26 therethrough is completely filled by the elastomeric material.

In this arrangement by deflecting the wheel at the free end of the plates upwardly or downwardly relative to the casing, the plates together with the shaft 26 upon which they are mounted are rotated about the longitudinal axis of the core portion of the shaft such that the flange portion of the shaft is leveraged against the side wall of the casing to compress the elastomeric material between the flange portion and the opposing side wall. The compression of the elastomeric material serves to bias the flange portion to return to a parallel configuration with the side wall of the casting to return the wheel to an undeflected position. The longitudinal axis of the core portion of the shaft thus defines a first horizontal axis of rotation of the castor wheel assembly at an upper corner of the cross section of the tubular casing adjacent the side wall of the casing which is farthest from the wheel, about which the wheel rotates when deflected relative to the casing.

The wheel 38 is coupled between the outer ends of the two pivot arms 34 for rotation about a second horizontal axis extending between the plates which is parallel and spaced radially outward relative to the first horizontal axis. When the core portion 28 of the shaft 26 is positioned in an upper one of the corners of the casing as shown in FIG. 3 with the flange portion depending downwardly therefrom along the side wall, the wheel is spaced outwardly from the opposing side wall. The wheel and the second horizontal axis about which it rotates are moveable together with the pivot arms about the first axis at the longitudinal axis of the core portion 28 of the shaft so that the depending flange portion of the shaft is deflected towards the wheel at the free end thereof when the wheel is deflected upwardly relative to the casing. In this arrangement the elastomeric material is arranged to be compressed by relative rotation between the shaft and the casing responsive to the upward deflection of the castor wheel relative to the casing.

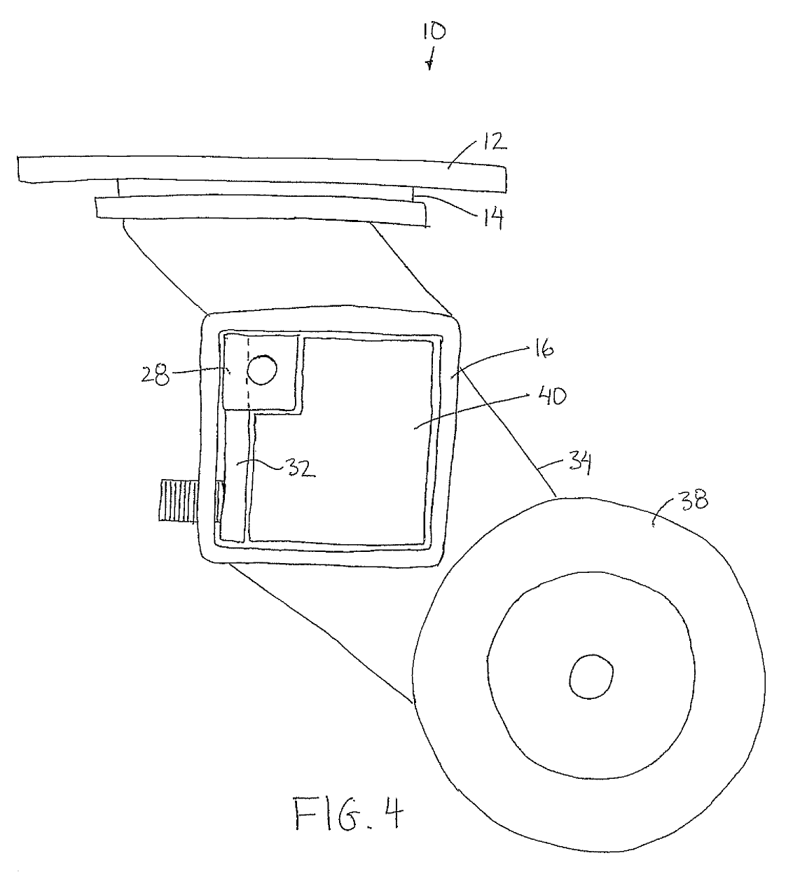

The shaft and the elastomeric material 40 are arranged to be slidably received through either one of the open ends of the casing during assembly of the castor wheel assembly when the pivot arms 34 are detached from the shaft. Accordingly the offset of the swivel axis of the swivel member relative to the casing can be readily reversed so that the core portion of the shaft and the first horizontal axis can be relocated from being adjacent the side wall farthest from the vertical axis to being adjacent the side wall 24 substantially at the vertical axis as shown in FIG. 4. The distance between the second axis about which the wheel rotates in a radial direction relative to the vertical swivel axis can thus be adjusted from a small radial distance as shown in FIG. 3 to a considerably larger radius as shown in FIG. 4 simply by assembling the components in a different configuration without affecting the range of upward deflection of the castor wheel relative to the casing or the responsiveness of the elastomeric material.

In addition to adjusting the radius, the ride height of the castor wheel in an undeflected position relative to the base member can also be adjusted using an adjustment screw 42 which is threadably received through the side wall 24 of the casing against which the flange portion 32 of the shaft lays in the undeflected position of the wheel. The screw 42 is threaded through the side wall adjacent the free end of the flange portion farthest from the first horizontal axis so that threading the screw into the casing causes the screw to project into the casing beyond the inner surface of the casing wall to deflect the free end of the flange portion away from the casing wall and cause partial rotation of the shaft 26 relative to the surrounding casing. This causes the elastomeric material between the flange portion and the opposing side wall to be partly pre-compressed for pre-tensioning the suspension of the castor wheel assembly while also serving to rotate the pivot arms together with the shaft relative to the casing to raise the wheel at the outer end of the pivot arms upwardly relative to the casing, thus affecting the rolling height of the wheel relative to the base member of the castor wheel assembly. A plurality of castor wheel assemblies supporting a common object can thus be levelled relative to one another.

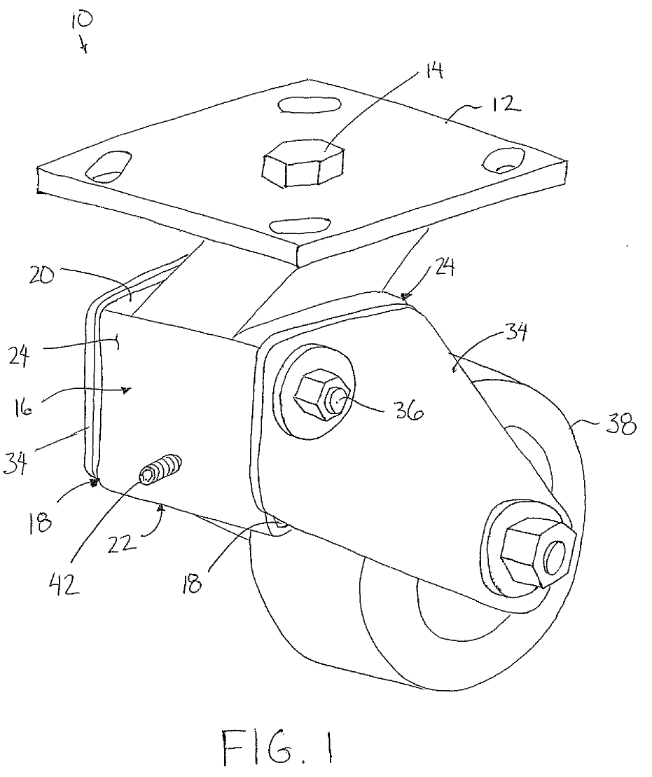

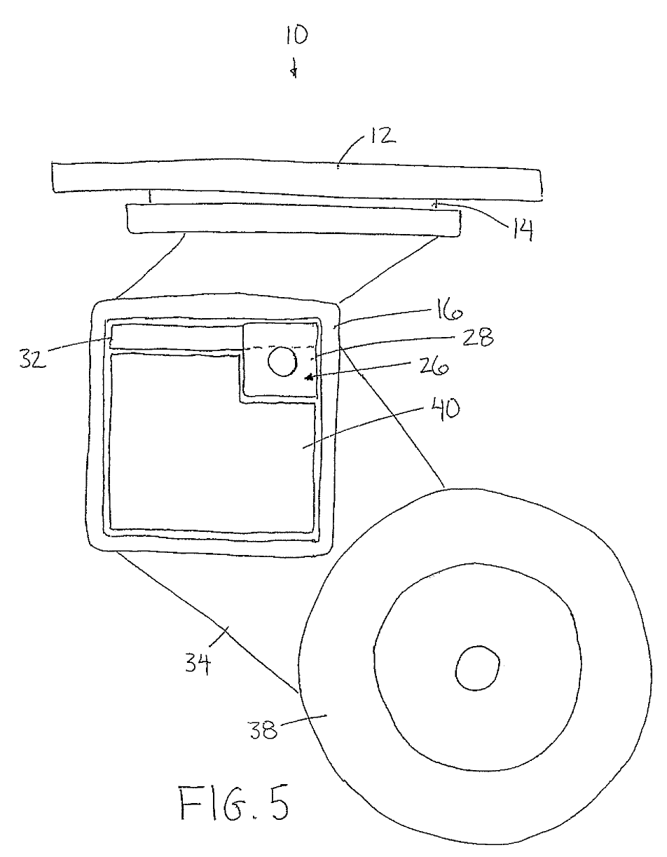

Turning now to the embodiment of FIG. 5, the components of the castor wheel assembly are shown in a further configuration in which the core portion 28 is again shown in a upper one of the corners of the square cross section of the casing in abutment with the top wall and one of the side walls, however the flange portion instead projects laterally along the top wall of the casing a full width of the casing between the two side walls of the casing. The core portion of the shaft which defines the location of the first horizontal axis about which the shaft rotates is located adjacent the side wall which is nearest to the wheel contrary to the embodiment of FIG. 1. In this embodiment, upward deflection of the wheel will cause the shaft to be leveraged against the top wall of the casing such that the free end of the flange portion is deflected downwardly to compress the elastomeric material against the bottom wall of the casing.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A castor wheel assembly for supporting an object thereon for rolling movement along the ground, the assembly comprising:
a base member arranged for supporting the object thereon;
a tubular casing extending in axial direction between a pair of opposed ends of the casing;
a swivel member supporting the base member on the tubular casing for relative rotation about a vertical swivel axis;
a shaft extending through the tubular casing between the opposed ends of the casing and being supported for pivotal movement relative to the casing about a first horizontal axis extending in the axial direction between the opposed ends of the casing;
a pair of arms coupled to the shaft at the opposed ends of the casing respectively so as to be arranged for rotation with the shaft relative to the casing about the first horizontal axis;
a wheel coupled between the pair of arms for rotation about a second horizontal axis oriented parallel to and spaced from the first horizontal axis;
the wheel extending below a bottom edge of the arms so as to be arranged for rolling engagement along the ground;
the shaft comprising at least one flange portion which is rotatable with the arms relative to the casing about the first horizontal axis;
said at least one flange portion spanning radially from the first horizontal axis along a length of the shaft between the opposed ends of the casing;
elastomeric material supporting the shaft in the casing in abutment with one wall of the casing such that the elastomeric material spans between the shaft and an opposing wall of the casing;
the elastomeric material being arranged to be compressed by relative rotation between the shaft and the casing responsive to upward deflection of the castor wheel relative to the casing.

2. The assembly according to claim 1 wherein said at least one flange portion comprises a single flange abutted along one wall of the casing.

3. The assembly according to claim 1 wherein the first horizontal axis is located adjacent a top wall of the casing.

4. The assembly according to claim 1 wherein said at least one flange portion is arranged to span substantially a full cross sectional dimension of the casing.

5. The assembly according to claim 4 wherein said at least one flange portion is arranged to lay flat against one wall of the housing and the elastomeric material spans between the flange portion and an opposing wall of the casing lying parallel to the flange portion.

6. The assembly according to claim 1 wherein the casing is square in cross section and the first horizontal axis is positioned in one corner of the square cross section of the casing.

7. The assembly according to claim 6 wherein said at least one flange portion spans a full distance between two adjacent corners of the square cross section of casing.

8. The assembly according to claim 6 wherein the first horizontal axis is positioned adjacent an upper one of the corners of the cross section of the casing and said at least one flange portions comprises a single flange depending downwardly from the first horizontal axis to span a full height of the casing.

9. The assembly according to claim 1 wherein said at least one flange portion comprises a single flange against one wall of the casing and the elastomeric material is arranged to substantially fill the casing between the flange portion and remaining ones of the walls of the casing.

10. The assembly according to claim 1 wherein the elastomeric material is arranged to span continuously across a full cross section of the casing between two opposed walls of the casing.

11. The assembly according to claim 1 wherein said at least one flange portion is located adjacent one wall of the casing and wherein there is provided an adjustment screw threadably received through said one wall so as to be arranged to displace the flange portion away from said one wall to pre-compress the elastomeric material such that the castor wheel is deflected upwardly relative to the casing.

12. The assembly according to claim 1 wherein the vertical swivel axis is arranged to be offset from the first horizontal axis.

13. The assembly according to claim 12 wherein the shaft and elastomeric material are arranged to be supported in the casing in two orientations which are reversible relative to one another, a radial distance of the second horizontal axis of the wheel relative to the vertical swivel axis being different from one another in the two orientations.

14. The assembly according to claim 1 wherein the tubular casing is square in cross section so as to define four walls, the shaft being abutted against two adjacent walls of the casing by the elastomeric material.
